(19) United States
(12) Patent Application Publication
(10) Pub. No.: US 2014/0114753 A1
(43) Pub. Date: Apr. 24, 2014

(54) METHOD AND SYSTEM FOR ALLOCATING BANDWIDTH BASED ON DEVICE USER RESPONSE

(71) Applicants: Hong XIAO, Acton, MA (US); Dongchen Wang, Concord, MA (US); Andre Turner, Belmont, MA (US); Azim Nasir, Foxboro, MA (US)

(72) Inventors: Hong XIAO, Acton, MA (US); Dongchen Wang, Concord, MA (US); Andre Turner, Belmont, MA (US); Azim Nasir, Foxboro, MA (US)

(73) Assignee: Verizon Patent and Licensing Inc., Basking, NJ (US)

(21) Appl. No.: 13/658,283

(22) Filed: Oct. 23, 2012

(51) Int. Cl. G06F 15/173; G06Q 30/02

(52) U.S. Cl. 705/14.49; 705/14.4; 709/226

(57) ABSTRACT

An approach for regulating the allocation of network bandwidth capacity based on user responsiveness to advertisement content is described. A bandwidth allocation platform determines, based on a metering of content delivered to a device via a network, the amount of content delivered is approaching a predetermined threshold of bandwidth allocated to the device by a provider of the network. The bandwidth allocation platform further determines, based on a monitoring of a duration or type of interaction or response of a user, an amount of additional bandwidth to be allocated to the device.

### BACKGROUND INFORMATION

Service providers are continually challenged to deliver value and convenience to consumers by providing compelling network services and advancing the underlying technologies. One area of interest has been the development of services and technologies for enhancing the content viewing experience of users. Many content rendering services and applications rely on the existing infrastructure of network service providers to convey content on demand to users. Oftentimes, fulfillment of content requests require additional bandwidth or data capacity to be allocated for the users, which can further tax the infrastructure of the network service provider. Unfortunately, there is currently no effective means of providing incentives to users requiring access to content via a network while also optimizing the allocation of limited network bandwidth capacity.

Based on the foregoing, there is a need for regulating the allocation of network bandwidth capacity based on user responsiveness to advertisement content.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for regulating the allocation of network bandwidth capacity based on user responsiveness to advertisement content, according to one embodiment;

FIG. 2 is a diagram depicting the components of a bandwidth allocation platform, according to one embodiment;

FIGS. 3A and 3B are flowcharts of processes for regulating the allocation of network bandwidth capacity based on user responsiveness to advertisement content, according to various embodiments;

FIGS. 4A-4C are diagrams of user interfaces depicting user interaction with the bandwidth allocation platform of FIG. 1, according to various embodiments;

FIG. 5 is a diagram of a computer system that can be used to implement various exemplary embodiments; and

FIG. 6 is a diagram of a chip set that can be used to implement an embodiment of the invention.

### DESCRIPTION OF THE PREFERRED EMBODIMENT

An apparatus, method and software for allocating network bandwidth capacity based on user responsiveness to advertisement content are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to advertisements or advertisement content, it is contemplated that these embodiments have applicability to content and media of various types. This may include, for example, commercials, web based media, notification messages, polls, instruction sets and the like. Still further, the content may be directly integrated with or related to featured (or requested) content, such as movies or audio related content required for on-demand execution. As will be discussed more fully herein, the advertisement content may be generated/provided by one or more third party advertisement providers for use in connection with an advertisement sharing scheme, content strategy, marketing strategy, marketing campaign or the like.

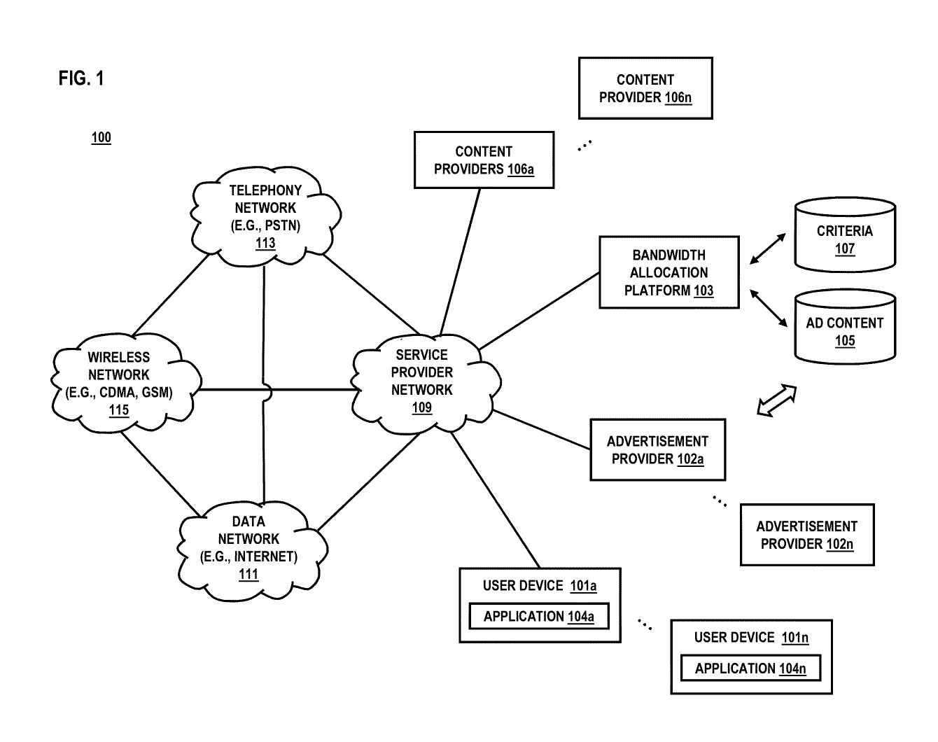

FIG. 1 is a diagram of a system for regulating the allocation of network bandwidth capacity based on user responsiveness to advertisement content, according to one embodiment. In certain embodiments, the bandwidth capacity may refer to frequency range, rate of data transfer, throughput, or an amount or threshold of data capable of being transmitted via the network, or a combination thereof. For the purpose of illustration herein, the bandwidth may be taken as synonymous with a data capacity (cap) of the network as established for a particular user or in response to fulfillment of a particular service. The system 100 includes a bandwidth allocation platform 103 that is configured to determine a type or duration of responsiveness to advertisement content 105 by one or more users of user devices 101a-101n (e.g., a mobile device, smart phone, netbook, tablet, laptop, set-top box, television) relative to an advertisement based bandwidth allocation scheme. For the purpose of explanation, the one or more user devices 101a-101n may be implemented as any communications enabled devices for interacting with the bandwidth allocation platform 103 via a network (e.g., service provider network 109).

The advertisement content 105 may be generated by one or more third party advertisement providers 102a-102n, referred to herein collectively as advertisement providers 102. Advertisement providers may include, for example, various retailers, merchants, product manufacturers, marketing agents, distribution or sales channels, vendors, etc. Still further, the advertisement providers 102 may also include one or more research groups or other agencies that may have an interest in consumer/user behavioral information. It is noted, therefore, that the advertisement providers 102 may be directly or indirectly associated with the advertisement content 105 and/or the product or service that is the subject of the advertisement.

As mentioned previously, the ability of users to access content via their devices, whether mobile of stationary, is central to the user experience. For example, many user devices nowadays feature content rendering applications that enable users to acquire and subsequently play streaming or on-demand content. This enables users to view movies, engage in real-time video conferencing, access music collections and other activities requiring significant amounts of bandwidth or data capacity to be provisioned by the network service provider of the user. The ability of the underlying network infrastructure of the provider to allocate the necessary bandwidth is critical to the success of the developers of the content rendering applications as well as the users. Unfortunately, there is currently no effective means of enabling network service providers, whose infrastructure is relied upon for content delivery, to regulate and optimize the allocation of limited network resources. This includes, for example, ensuring device users are provided incentives for receiving content while also incenting network providers for enabling use of their network infrastructure.

To address this issue, system 100 of FIG. 1 enables service providers to regulate the amount of bandwidth to be reserved in connection with a content request/delivery requirement of a user device 101a-101n. The regulation scheme, as managed by a bandwidth allocation platform 103 of the system 100, may be based on a measuring of a user response to advertisement content 105 delivered to the user devices 101a-101n in association with the requested content of one or more content providers 106a-106n. By way of this regulation scheme, the type or duration of response of the user to the advertisement content 105 may be translated into a requisite amount of bandwidth (e.g., adaptation of a data cap) to be reserved and/or allocated for the user devices 101a-101n.

In certain embodiments, the one or more content providers 106a-106n provide the requested content (as a service) in response to the execution of content rendering application 104a-104n, such as a media players or on demand video players. The content rendering applications 104a-104n may be dedicated applications provided by the content providers 106a-106n or third party utilities capable of processing content of various formats. In either case, the content is delivered via a communication network (e.g., service provider network 109) of a network provider to the user devices 101a-101n upon request/activation via the content rendering applications 104a-104n. The user devices 101a-101n are subscribed to and/or configured for access of the network 109 by way of a subscription and/or network access agreement.

In certain embodiments, the advertisement content 105 is provided by one or more advertisement providers 102a-102n. The advertisement providers 102a-102n may interact with the bandwidth allocation platform 103, such as via a subscription and/or partnership agreement, to enable delivery of advertisement content 105 to the devices 101a-101n. Per this arrangement, the advertisement providers 102a-102n may directly upload the advertisement content 105 to the bandwidth allocation platform 103. Alternatively, the bandwidth allocation platform 103 may retrieve the advertisement content 105 from designated sources of the advertisement providers 102a-102n for use in directing the advertisements to user devices 101a-101n.

Per this arrangement, for the purpose of illustration, the bandwidth allocation platform 103 may be implemented as an intermediary service or component for facilitating the delivery of both requested content (e.g., movies, applications) of providers 106a-106n and advertisement content 105. Also, the bandwidth allocation platform 103 may be configured to interact with or within the network infrastructure (e.g., service provider network 109) common to the set of requesting user devices 101a-101n. By way of this approach, the bandwidth allocation platform 103 may orchestrate the delivery of different types of content as well as enable various monitoring processes for determining user response to the advertisements. It is noted, in certain embodiments, that the platform 103 may be implemented as a hosted solution (e.g., cloud service), a web service, an application programming interface (API) or as a direct executable of user device 101a-101n.

In certain embodiments, as an intermediary service or component, the advertisement content 105 rendered to a device 101a-101n via applications 104a-104n may be independent of the requested content (e.g., movie content) of a user. Alternatively, the advertisement content 105 may be directly related to the requested content per a target marketing scheme (e.g., an advertisement pertaining to the same subject matter/theme of the movie). Still further, the advertisement content 105 may be associated with one or more preferences established by users of devices 101a-101n or based on preferences of the advertisement providers 102a-102n.

Also, the advertisement content 105 may be delivered via service provider network 109 concurrent with or in association with the requested content. The bandwidth allocation platform 103 may support various means of rendering of the advertisement content 105; wherein the requirements are based on the operation of the respective content rendering applications 104a-104n at the devices 101a-101n. By way of example, the advertisement content 105 may be presented (as rendered by the application 106a-106n) at the same time as the requested content of providers 106a-106n. Under this scenario, the advertisement content 105 and requested content are presented via a common user interface or rendered based on dependent execution (e.g., a dynamic advertisement that adapts based on a current duration/scene of a movie). Alternatively, the advertisement content 105 may be presented via a separate user interface than that of the content rendering applications 104a-104n. Under this scenario, for example, the separate user interface may be an independent pop-up window or browser execution. Also, execution of the independent window or browser may cause temporary masking/disabling of the content rendering applications 104a-104n until a user response (input) is received.

In certain embodiments, the advertisement content is initiated for rendering by the bandwidth allocation platform 103 based on a metering of the content by the network provider. By way of example, metering pertains to a procedure for measuring an amount of data consumed and/or exchanged by the user devices 101a-101n with respect to the service provider network 109. In the case of requested content at a device 101a-101n, such as movie content, the metering result may be expressed as an average/aggregate amount of data consumed over a period of time by the user. This metering result is then compared to the amount of bandwidth allocated by the service provider for the respective user devices 101a-101n for determining what amount of the allocation remains. For the purpose of illustration, this may be expressed as:

The amount of bandwidth allocated−The amount of bandwidth consumed=The amount of bandwidth remaining.

When the remaining amount of available bandwidth (e.g., as measured in bits per second) is approaching or within a predetermined threshold of the data cap, the bandwidth allocation platform 103 triggers execution of an indicator for indicating this status. By way of example, the indicator may include a graphical element for indicating a metering result (e.g., an amount of content consumption of the requesting user device 101 over time). As another example, the indicator may visually specify an amount of time remaining for continued viewing of the requested content as a result of the content already consumed. Still further, the indicator may include a visual prompt or notification message for requesting that the user view advertisement content 105 in exchange for an additional amount of bandwidth to be allocated (e.g., reserved) for devices 101a-101n.

It is noted that the indicator may be rendered concurrent with the content via the content rendering application 104a-104n. The indicator may also specify criteria and/or types of responses required for the user to achieve certain levels of bandwidth allocation. For example, the indicator may specify that a purchase action of the product associated with an advertisement may result in Y amount of bandwidth allocation while viewing of the advertisement results in X. Still further, the indicator may be activated, such as by way of a user provided input, for initiating execution of the advertisement content based on the determined metering result. Under this scenario, the user may tap or activate an action button at the indicator for launching the advertisement.

In certain embodiments, the bandwidth allocation platform 103 receives a user response (input) to the rendered advertisement content 105. The input may be with a type or duration of user response as defined by response criteria established by the advertisement provider 102a-102n. The criteria 107 may also be established by the provider of the network (e.g., service provider network 109). For the purpose of illustration, the response criteria 107 may specify a collection of variables and/or semantics for indicating a type of behavior of the user. In addition, the criteria 107 may include various rules and associated metrics for enabling the bandwidth allocation platform 103 to evaluate whether an additional amount of bandwidth is to be allocated by the network service provider pursuant to the user response. The extent to which the criteria 107 is fulfilled, based on processing of the input, determines the amount of additional bandwidth to be allocated. Hence, users are incentivized with additional data capacity by the network provider based on one or more favorable responses to the advertisement content 105.

In certain embodiments, the types of responses to the advertisement content 105 per the input may be monitored by the bandwidth allocation platform 103 upon rendering of the advertisement. The monitoring corresponds to a period of recording of the type and duration of response of the user per the established criteria 107. As a result of the monitoring, the platform 103 correlates the response types to one or more actions capable of being initiated by users of devices 101a-101n. The response input may include, for example, initiation of a purchase action associated with the advertisement, a forwarding of the advertisement, an activation of the advertisement (e.g., play), a number or sequence of the inputs provided by a user per the advertisement (e.g., click-throughs), a storing of the advertisement (e.g., storing of a coupon or document), a ranking of the advertisement (e.g., feedback about the effectiveness of the advertisement), an inquiry action associated with the advertisement (e.g., submission of a query or question) or the like.

In certain embodiments, the bandwidth allocation platform 103 may further monitor the duration of response of the user to the advertisement content 105. The duration of response may correspond to the amount of time of viewing/consumption of the advertisement content, such as in the case of video or multimedia based advertisement content 105. Alternatively, the duration of response may pertain to a response time of the user. This may include a measured response of the user to a question, a link associated with the advertisement, a rate of advancement of the user to another portion of the advertisement, an action button (e.g., a button to initiate purchase of the advertised product), etc.

In certain embodiments, the bandwidth allocation platform 103 determines the amount of additional bandwidth to allocate to the requesting user devices 101a-101n based on the monitored user response. This may include, for example, selecting a bandwidth allocation tier (data cap tier) to associate with the requesting user devices 101a-101n based on the determined type and/or duration of response. Under this scenario, a lower tier may correspond to a lower determined level of response type or duration while a higher tier corresponds to a higher determined level of response type or duration. Alternatively, the determined type or duration of response may be processed as an input for a bandwidth allocation algorithm or scheme to determine the additional bandwidth to allocate. It is noted the allocation scheme employed may vary depending on the requirements and capacity of the infrastructure, the needs of the requesting user (customer of the network provider) and other resource scaling or performance factors.

In certain embodiments, the bandwidth allocation platform 103 initiates allocation of the amount of additional bandwidth to the user devices 101a-101n based on the allocation determination. This may include, for example, generating a signal for alerting a control system of the network infrastructure to reserve/release the determined allocation. As a result of this execution, the indicator rendered to the user may also be updated to reflect the additional bandwidth capacity. This may include, for example, indicating the amount of time available for consumption of the requested content has increased or that metering of the requested content has been disabled. Still further, in certain instances, the indicator may specify that the bandwidth allocation is sufficient for consuming requested content of different quality or formats of content. Under this scenario, the quality or format of the content may be associated with higher bandwidth allocations.

It is contemplated, in certain embodiments, that the indicator may be reduced in prominence, re-oriented to a different position of the user interface or removed to indicate the user has fulfilled one or more requirements for interaction with the advertisement. This may be in contrast to the orientation or position of the indicator prior to rendering of an advertisement; wherein the indicator is presented in a manner to be readily viewed by users of devices 101a-101n. In certain instances, user interaction with the advertisement content 105 and subsequent updating of the indicator may also correspond to resumed execution of the requested content. This execution is applicable in instances where the content rendering application 104a-104n disrupts/pauses execution of the requested content when the level of consumption is within range of the bandwidth threshold; thus forcing rendering of the advertisement content 105.

In addition to determining an amount of bandwidth to be allocated and initiating said allocation, it is noted the bandwidth allocation platform 103 may also be employed as a means of regulating the network of a network provider. For example, in certain embodiments, the bandwidth allocation platform 103 may be used in connection with a load balancing scheme for preplanning upcoming load requirements to the network. The preplanning may be based on the monitoring of user response or lack thereof to advertisements for enabling additional bandwidth allocation. As another example, a response history of user devices 101a-101n may be logged for future capacity planning Under this scenario, the network provider may determine which periods of the day correspond to greater periods of responsiveness and hence bandwidth to be allocated. It is further noted, per an arrangement with the advertisement provider, that the response history data may be shared for analyzing and optimizing the effectiveness of advertisement content 105.

In certain embodiments, user devices 101a-101n, the bandwidth allocation platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions.

According to exemplary embodiments, one or more of the user devices 101a-101n may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smartphone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

The bandwidth allocation platform 103 can interact with any of user devices 101a-101n to monitor a user response to rendered advertisement content 105 and initiate bandwidth allocation based on the monitored results. Exemplary components of platform 103, according to one embodiment, are described below.

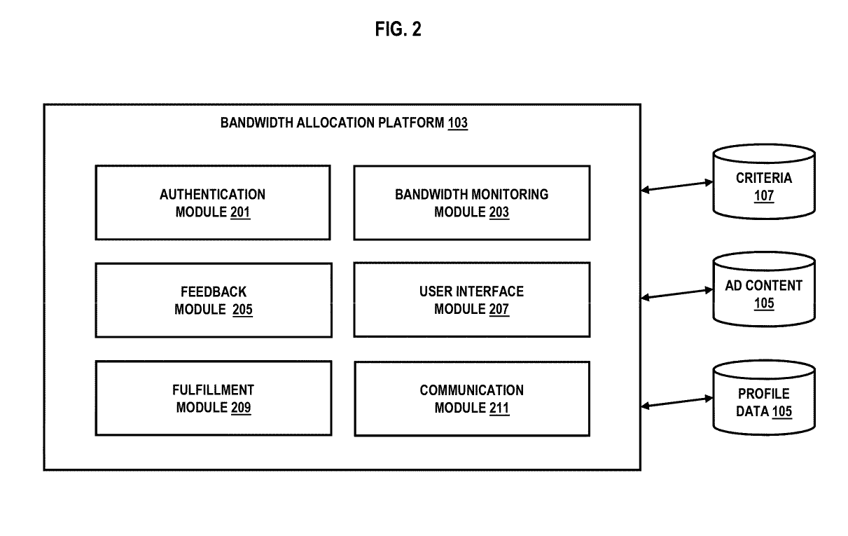

FIG. 2 is a diagram of a bandwidth allocation platform, according to one embodiment. The bandwidth allocation platform 103 includes various executable modules for performing one or more computing, data processing and network based instructions that in combination provide a means for regulating the allocation of network bandwidth capacity based on user responsiveness to advertisement content. Such modules can be implemented in hardware, firmware, software or a combination thereof. By way of example, the bandwidth allocation platform 103 may include an authentication module 201, a bandwidth monitoring module 203, a feedback module 205, a user interface module 207, a fulfillment module 209 and a communication module 211.

In addition, the bandwidth allocation platform 103 also maintains advertisement content 105 as received from various advertisement providers 102a-102n (e.g., a retailer/vendor) and response criteria 107 pertaining to the various response input types of users of devices 101a-101n. Also, profile information 213 is maintained for the users of devices 101a-101n and the advertisement providers 102a-102n. It is noted that the modules 201-211 of the bandwidth allocation platform 103 may access databases 105-107 for performing various executable functions.

In one embodiment, an authentication module 201 authenticates users and user devices 101a-101n for interaction with the bandwidth allocation platform 103. By way of example, the authentication module 201 receives a request from a user of a device 101 to subscribe to the platform 103. Alternatively, the authentication platform 103 may enable user interaction with the platform 103 based on execution of the content rendering application 104a-104n of a respective user device 101a-101n. The subscription process may include establishing preferred interests and activities for use in receiving targeted advertisement content 105. For example, the user may indicate a preference for vehicle or clothing related advertisements. Once established, the preferences and settings of the user may be stored in connection with profile information pertaining to the user. Of note, in certain instances, the initial authentication process may also involve the activation and/or downloading of the content rendering application 104a-104n for enabling the viewing of advertisement content via user devices 101a-101n.

Similarly, one or more advertisement providers 102a-102n may subscribe with the bandwidth allocation platform 103 for specifying the location of advertisement content 105 to be directed to users, i.e., from one or more remote database locations. In addition, the subscription process may include specifying criteria 107 for processing/interpreting the types of responses of a user to advertisement content 105.

The authentication process performed by the module 201 may also include receiving and validating a login name and/or user identification value provided or established during subscription. Alternatively, the login procedure may be executed in response to an API call of the content rendering application 104a-104n for accessing the platform 103. The login name and/or user identification value may be received as input from API or via a graphical user interface of the application 104a-104n (e.g., per user interface module 207). Alternatively, the login procedure may be performed through automated association of profile information with an identification signal generated by an active device, i.e., a carrier detection signal.

In one embodiment, the bandwidth monitoring module 203 determines an amount of requested content consumed by a user device 101a-101n. In addition, the bandwidth monitoring module 203 determines whether or not the amount of content consumed is approaching, to within a predetermined threshold, an amount of bandwidth capacity of the user device 101a-101n. These metrics may be calculated periodically by the bandwidth monitoring module 203. Of note, the bandwidth monitoring module 203 may interact with a metering device and/or agent of the network provider for acquiring these metrics.

The bandwidth monitoring module 203 also triggers updating of an indicator for representing/depicting the current metering status. This may include, for example, calling upon the user interface module 207 to generate and/or update the indicator as presented to a user interface of the content rendering application 104a-104n. In addition, advertisement content 105 may be queued for execution.

In one embodiment, the feedback module 205 determines user activation of the queued advertisement content 105 based on an input response of the user at the corresponding user devices 101. Based on this input response, the feedback module 205 then initiates a rendering of the advertisement content 105 to the user devices 101a-101n accordingly. In addition, the feedback module 205 also determines a type and/or duration of response of users to the rendered advertisement. By way of example, the feedback module 205 determines what types of actions are initiated during or subsequent to presentment or playback of the advertisement. This includes processing a response input of the user against the response criteria 107 corresponding to the selected advertisement.

Response types executed by the user (during presentment or playback of an advertisement) may include initiation of a purchase action, a request for information, initiation of a phone call, a request to replay the advertisement, a forwarding of the advertisement, a generating of a comment or the like. The feedback module 205 may also determine a number or a sequence of clicks of the user with respect to the advertisement. Under this scenario, the clicks may pertain to a mouse or touch based input at the user device 101 for activating various links or action buttons featured with respect to the advertisement.

In addition to determining the type of action, the feedback module 205 also determines the duration of response of the user to the advertisement content 105. This includes determining the amount of interaction of the user with the advertisement, such as the amount of time of active viewing of the advertisement. Also, the duration of time may be associated with a response time of the user to a prompt associated with the advertisement. For example, a prompt may be presented during execution of a video advertisement for requesting user commentary or rating of the advertisement. Under this scenario, the feedback module 205 determines the length of time or duration for the user to respond to the prompt.

Once the type or duration of response is determined, the feedback module 205 transmits the results to the fulfillment module 209. The fulfillment module 209, in certain embodiments, determines a level of additional bandwidth to allocate to the user based on the type or duration of response of the user. By way of example, the fulfillment module 209 determines whether the type or duration of the response meets the criteria 107 established by the advertisement provider 102 and/or provider of the network (e.g., service provider network 109). This may include, for example, associating the number of clicks, duration of time and other response type characteristics with a predetermined bandwidth capacity tier authorized by the service provider. Depending on the requirement of the advertisement provider 102 and/or network provider, the fulfillment module 209 may also process the criteria against one or more algorithms for determining a response level. As such, the level of response determines the tier, wherein higher levels of response are associated with higher tiers of bandwidth capacity allocation.

The fulfillment module 209 also initiates allocation of the bandwidth based on the determined amount to be allocated. Under this scenario, the fulfillment module 209 may generate a signal to a control system, server or regulation agent of the network provider for triggering the reservation/release of the requisite amount of bandwidth for the user devices. It is noted that the signal may be transmitted accordingly via the communication module 211.

In one embodiment, the user interface module 207 facilitates generation of various interfaces for enabling users and advertisement providers to interact with the bandwidth allocation platform 103. This includes, for example, generation of a configuration interface for enabling advertisement providers to input and/or define response criteria 107. Still further, the user interface module 207 may cause generation of an indicator at the content rendering application 104a-104n for representing a metering result, amount of remaining bandwidth allocation, time of execution of requested content or the like. The user interface module 207 generates different user interface elements, such as action buttons, for receiving the appropriate input from users in connection with the advertisement content 105 by way of various application programming interfaces (APIs) or other function calls.

The above described modules 201-211 and components of the bandwidth allocation platform 103 can be implemented in hardware, firmware, software, or a combination thereof. Though depicted as a separate entity in FIG. 1, it is contemplated that the bandwidth allocation platform 103 may be implemented for direct operation by respective user devices 101. As such, the platform 103 generates direct signal inputs by way of the operating system of the device for interacting with the user interfaces generated via module 207. In another embodiment, one or more of the modules 201-211 may be implemented for operation as a platform 103 maintained as a hosted solution.

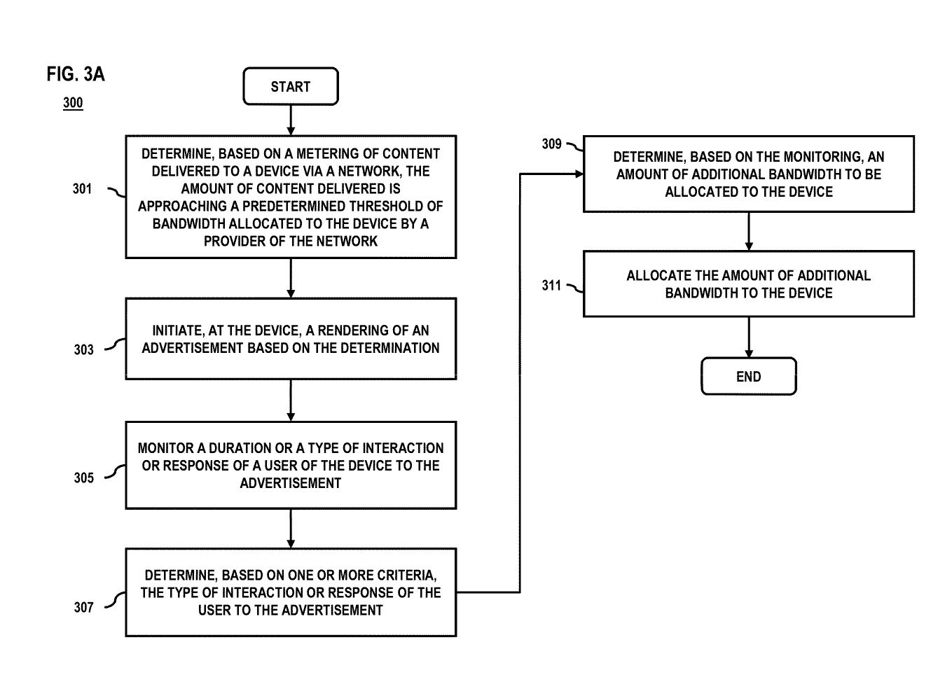

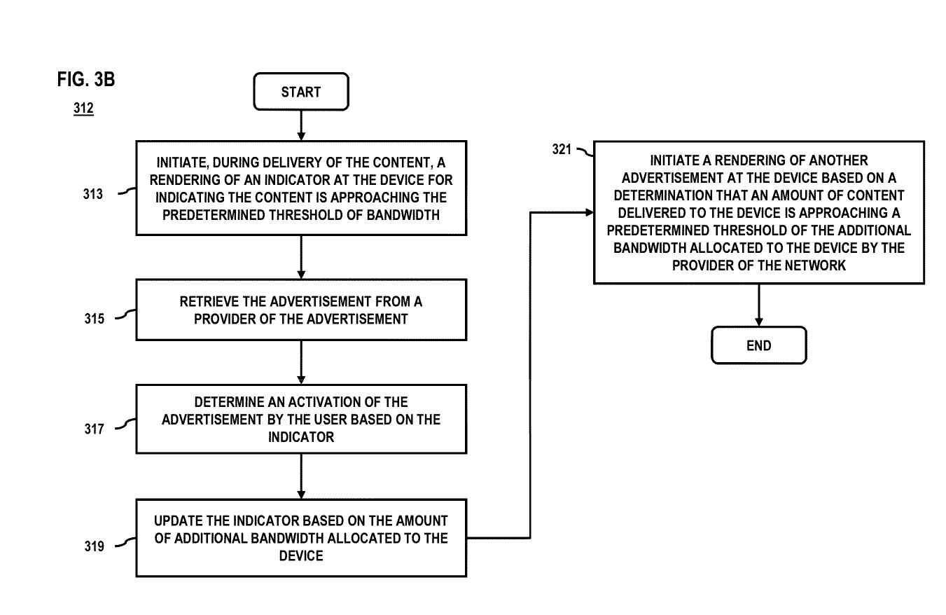

FIGS. 3A and 3B are flowcharts of processes for regulating the allocation of network bandwidth capacity based on user responsiveness to advertisement content, according to various embodiments. For the purpose of illustration, the processes are described with respect to FIG. 1. It is noted that the steps of the processes may be performed in any suitable order, as well as combined or separated in any suitable manner.

In step 301 of process 300, the bandwidth allocation platform 103 determines, based on a metering of content delivered to a device via a network, the amount of content delivered is approaching a predetermined threshold of bandwidth allocated to the device by a provider of the network. In another step 303, the platform 103 initiates, at the device, a rendering of an advertisement based on the determination. As noted previously, the advertisement content 105 rendered may be based on preferences specified by the user as profile information or based on the preferences of an advertisement provider 102a-102n (e.g., per a marketing scheme).

In step 305, the bandwidth allocation platform 103 monitors the duration or a type of interaction or response of a user of the device to the advertisement. As noted previously, the duration and type of interaction or response of the user is based on an input provided by the user via the device—i.e., during rendering of the advertisement. Per step 307, the bandwidth allocation platform 103 determines, based on one or more criteria, the type of interaction or response of the user to the advertisement. As noted previously, the one or more criteria are defined by the provider of the advertisement or the provider of the network.

The one or more criteria as defined may include a purchase action associated with the advertisement, a forwarding of the advertisement, an activation of the advertisement, a number or sequence of the inputs provided by a user, a storing of the advertisement, a ranking of the advertisement, an inquiry action associated with the advertisement, an amount of consumption of the advertisement, or a combination thereof. Also, in certain instances, the one or more criteria may be rendered at the device concurrent with the advertisement for specifying the input to be provided by the user—i.e., providing the user with the requirements for receiving additional bandwidth incentives.

In step 309, the bandwidth allocation platform 103 determines, based on the monitoring, an amount of additional bandwidth to be allocated to the device. In another step 311, the bandwidth allocation platform 103 initiates allocation of the amount of additional bandwidth to the device. This may include generating a signal to a system or agent of the network provider for reserving and/or releasing bandwidth capacity for subscribed user devices. As noted previously, the additional bandwidth may be associated with a different quality or format of the content or a disabling of the metering of the content.

In step 313 of process 312 (FIG. 3B), the bandwidth allocation platform 103 initiates, during delivery of the content, a rendering of an indicator at the device for indicating the content is approaching the predetermined threshold of bandwidth. As noted, the indicator may convey a metering result, a content viewing duration (e.g., a remaining amount of time remaining) or a prompt for requesting an input from the user for activation of the advertisement. The indicator may also be rendered to the device concurrent with the content, such that it may affect the execution of the content. By way of example, the indicator may be rendered as a modal pop-up instance, wherein the content is masked or rendered disabled pending a response input from the user to the indicator.

In another step 315, the platform 103 retrieves the advertisement from a provider of the advertisement, i.e., a source specified by the advertisement provider. This may include, for example, a remote data source of the provider or a local database as maintained by the platform 103. It is noted that one or more advertisements may be queued by the platform 103 for execution in connection with requested content to be rendered to the user device. Also, the advertisement may be retrieved based on the type of content delivered to the device, preferences of the user of the device or preferences of the provider of the advertisement

In step 317, the bandwidth allocation platform 103 determines an activation of the advertisement by the user based on the indicator. This may correspond to step 303 and may include, for example, user selection of the indicator via a touch input or mouse based input. Per step 319, the platform 103 updates the indicator based on the amount of additional bandwidth allocated to the device. By way of example, when an additional five megabits per second (5 Mbps) are allocated, the indicator is updated to reflect the current allocation plus the additional 5 Mbps. As such, the updated amount may represent an allowed throughput of the user device. Alternatively, the updated amount may be represented as an extended duration of time allowed for viewing of requested content.

In step 321, the bandwidth allocation platform 103 initiates a rendering of another advertisement at the device based on a determination that an amount of content delivered to the device is approaching a predetermined threshold of the additional bandwidth allocated to the device by the provider of the network. As noted, this corresponds to subsequent execution of the requested content after rendering of and response to a first advertisement. Hence, in the above described example of 5 Mbps additional allocation, the other advertisement is rendered when consumption of the content encroaches on this allocation. Under this scenario, therefore, the platform 103 enables the user to continually interact with advertisement content 105 for the purpose of activating additional bandwidth.

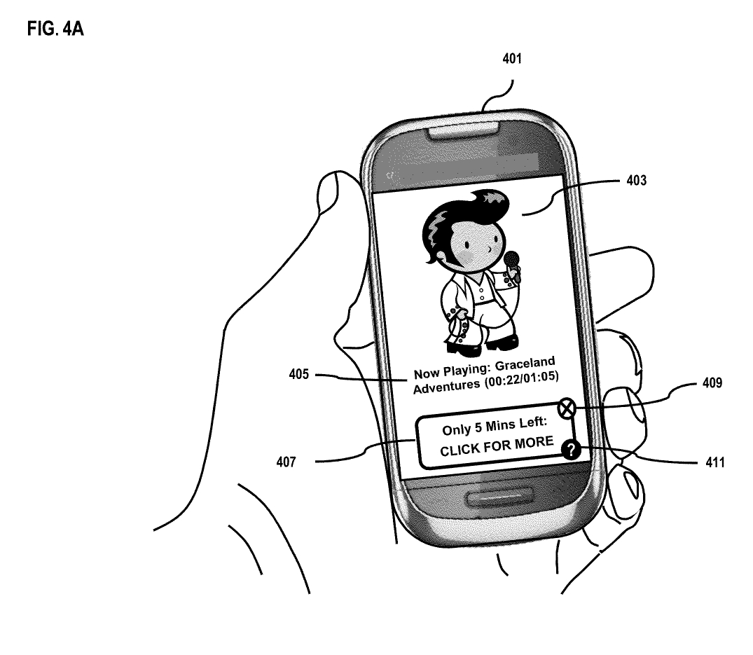

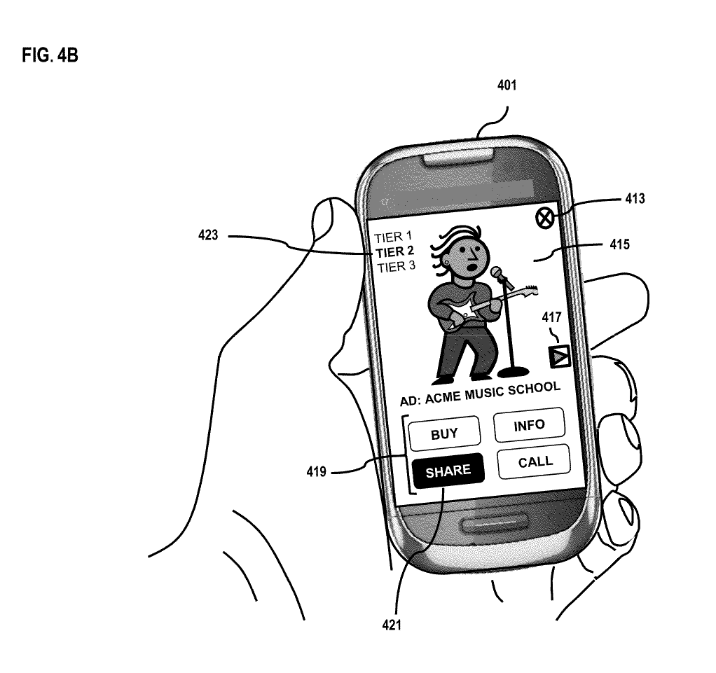

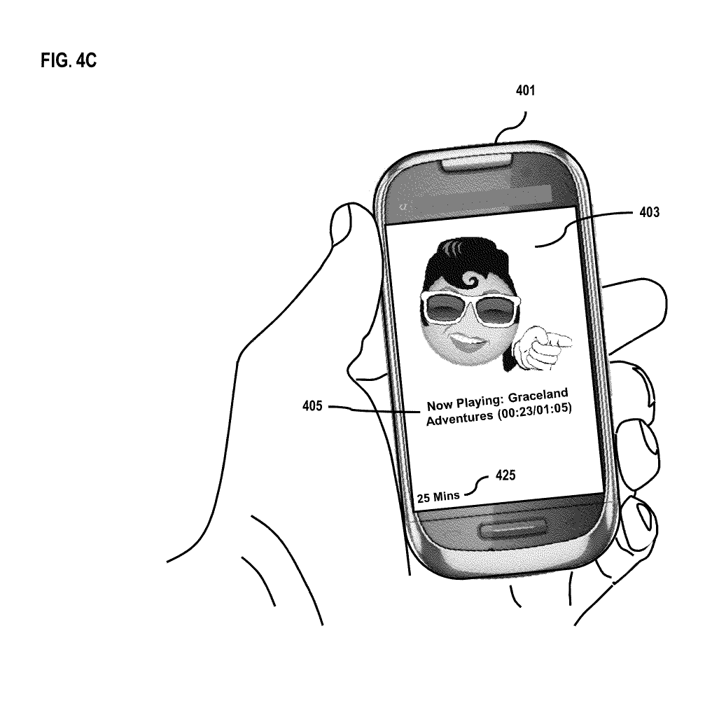

FIGS. 4A-4C are diagrams of user interfaces depicting user interaction with the bandwidth allocation platform of FIG. 1, according to various embodiments. For the purpose of illustration, the diagrams are described from the perspective of a use case of a user device 401 that accesses movie content 403 on demand from a movie content provider. Under this scenario, the bandwidth allocation platform 103 actively interacts with a movie player application of the device to enable the user to access additional bandwidth for viewing the content as needed. It is noted that while the user interface depictions correspond to the process of bandwidth allocation, the devices may be configured to cause presentment of various additional screens based on interaction of devices with the bandwidth allocation platform 103.

In FIG. 4A, as the user consumes the movie content 403, the bandwidth allocation platform 103 determines the amount of bandwidth originally allocated for the device 401 is approaching its limit. Under this scenario, the determination is based on a persistent metering of the content and overall activity of the user device 401 as it consumes data via the service provider network 109. Of note, the limit may correspond to an agreed upon bandwidth threshold as established, for example, via a subscription or contractual arrangement between the user of the device 401 and the network provider.

Based on the metering result, the platform 103 causes a rendering of an indicator 407 for specifying the amount of time remaining for viewing of the movie content 403. In this example, the amount of time remaining is presented via the indicator 407 as five minutes. This duration corresponds to the amount of bandwidth consumed by the device 401 to this point versus the upper bandwidth limit. As a result, the amount of remaining time (five minutes) is insufficient for enabling the user of the device 401 to enjoy the entire movie 403; which according to the caption 405 has a total running time of one hour five minutes.

The indicator 407 also presents an instruction that reads “CLICK FOR MORE” for indicating the user may activate/acquire more time and/or bandwidth for viewing the movie 403 by selecting the indicator 407. The user may provide a touch input to the display of the mobile device 401 for selecting a help action button 411, which causes rendering of one or more instructions and/or criteria for indicating how the user may be incentivized with the offer of additional bandwidth. Alternatively, the user may ignore the indicator 409 by selecting the exit action button 409. In this case, the user may continue to watch the movie 403 until the five minutes has elapsed. Under this scenario, however, the user selects the indicator 407, which causes the bandwidth allocation platform 403 to initiate rendering of an advertisement to view as shown in FIG. 4B.

In FIG. 4B, the user is presented with an advertisement 415 for “ACME Music School.” In this scenario, the advertisement is video based and is presented in connection with a target marketing scheme of an advertisement provider. Under this scenario, the target marking scheme is designed to appeal to the user based on the characteristics of the movie content 403 they were viewing. Alternatively, the advertisement 415 is presented based on user specified preferences as maintained in a user profile, i.e., user interests, hobbies, etc.

Once rendered, the user may interact with the advertisement 415 in various ways, including executing the video 415 by selecting a play action button 417. The user may also exit the advertisement 415 by selecting the exit action button 413. Still further, the user may be presented with multiple action buttons 419 for performing various actions in response to the video advertisement 415. This includes a BUY action button for initiating a purchase and/or registration of the user with the ACME Music School or an INFO action button for requesting additional information. Also presented are a SHARE action button 421 for enabling the user to forward the advertisement 415 to another person (e.g., member of their social network) and a CALL action button for initiating placement of a call to the music school.

Under this scenario, the bandwidth allocation platform 103 monitors the response of the user to the advertisement 415. This includes recording the various input selections of the user at the mobile device 401 for determining a duration or type of response of the user to the advertisement 415. By way of example, the platform 103 may observe that the user viewed the advertisement 415 in its entirety upon selection of the play action button 417. In addition, the platform 103 observes and records user selection of the SHARE action button 421. As such, the platform 103 correlates this input with the response criteria to determine whether the user satisfied one or more requirements for allocation of additional bandwidth. In addition, the platform 103 utilizes the response criteria to determine the amount of additional bandwidth to be allocated based on the determined user response.

In this example, the more the user interacts with the advertisement 415 via performance of one or more actions (e.g., per action buttons 419) or playback of the video 415, the more the bandwidth allocation. A bandwidth allocation tier status 423 may be presented along with the advertisement 415 for indicating a current bandwidth allocation tier allocated for the device 401. The tier 423 is adapted dynamically as the user further interacts with the advertisement 415, i.e., the allocation moves from Tier 2 to Tier 3 in response to the user placing a call to the school via the CALL action button.

In FIG. 4C, the user returns to and begins to play the movie content 403. Having responded to the advertisement 415 in various ways and for a given amount of time, the indicator 425 is updated to reflect the additional allocation of bandwidth afforded the user. Also, the indicator is (optionally) re-oriented to a different position of the user interface to indicate that the requirements for allocation have been met. It is noted that the placement of the indicator may be adapted for increased or decreased visibility by the user depending on whether or not the bandwidth threshold is being approached.

In this example, the indicator 425 shows the additional time provided for enabling the user to view the content 403. As a result of this extension, the user will not have to view another advertisement for up to 25 minutes. While not shown in this example, it is contemplated in future embodiments that the user may opt to view and interact with the next advertisement queued by the bandwidth allocation platform 103 in advance. For example, the user may select a view next action button (not shown) as a means of initiating rendering of another advertisement to further increase the bandwidth allocation or to disable metering of the content 403 entirely. By way of this approach, the user may view the entire movie 403 without further viewing of advertisements. In addition, the network service provider may further balance the load requirements of respective devices 401 configured to the network.

The exemplary techniques and systems presented herein enable network service providers to regulate their resources based on user interaction and response to one or more advertisements. By monitoring a type of duration of response of the user to the advertisement, the network provider is able to associate the user behavior with an amount of additional bandwidth to be allocated for a device of the user. Also, users are able receive useful advertisements, incentives and offers in exchange for additional bandwidth capacity per the network provider (e.g., provider of service provider network 109).

The processes described herein for regulating the allocation of network bandwidth capacity based on user responsiveness to advertisement content may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

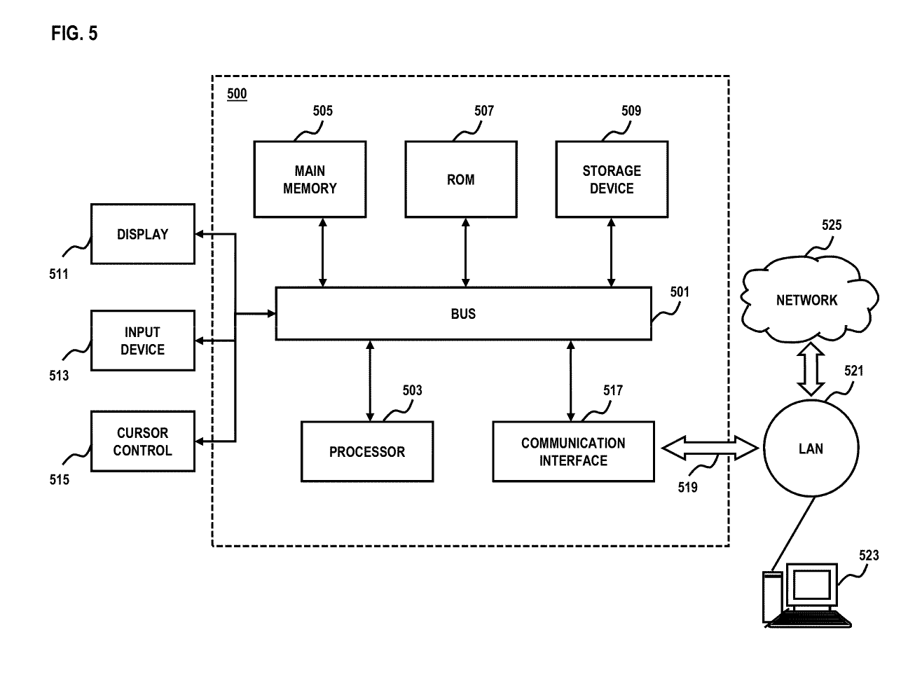

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIGS. 4A-4C, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

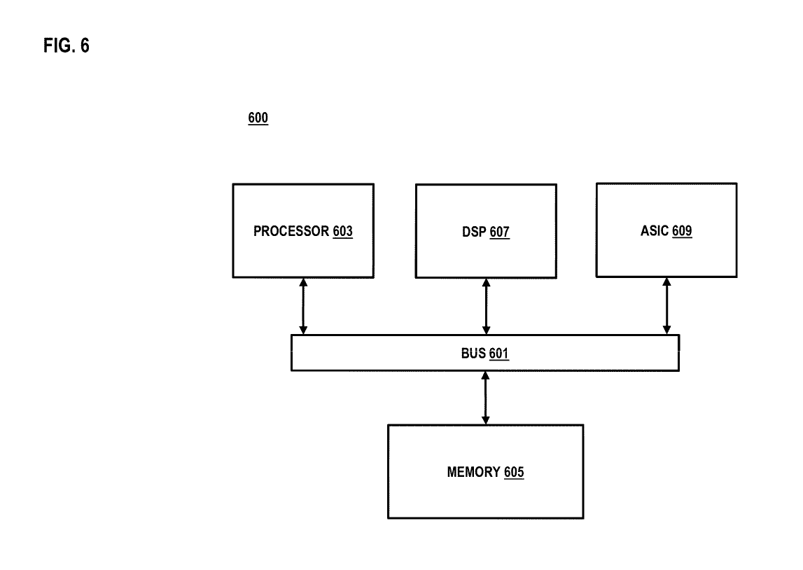

FIG. 6 illustrates a chip set or chip 600 upon which an embodiment of the invention may be implemented. Chip set 600 is programmed to regulate the allocation of network bandwidth capacity based on user responsiveness to advertisement content as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of regulating the allocation of network bandwidth capacity based on user responsiveness to advertisement content.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to regulate the allocation of network bandwidth capacity based on user responsiveness to advertisement content. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining, based on a metering of content delivered to a user via a network, the amount of content delivered is approaching a predetermined threshold of bandwidth allocated to the user by a provider of the network;
initiating, at a device associated with the user, a rendering of an advertisement based on the determination;
monitoring a duration or a type of interaction or response of the user to the advertisement; and
determining, based on the monitoring, an amount of additional bandwidth to be allocated to the device.

2. A method of claim 1, further comprising:
initiating allocation of the amount of additional bandwidth to the device,
wherein the additional bandwidth is associated with a different quality or format of the content or a disabling of the metering of the content.

3. A method of claim 1, further comprising:
determining, based on one or more criteria, the type of interaction or response of the user to the advertisement,
wherein the one or more criteria are defined by the provider of the advertisement or the provider of the network and the duration and type of interaction or response is based on an input provided by the user via the device.

4. A method of claim 3, wherein the one or more criteria include a purchase action associated with the advertisement, a forwarding of the advertisement, an activation of the advertisement, a number or sequence of the inputs provided by a user, a storing of the advertisement, a ranking of the advertisement, an inquiry action associated with the advertisement, an amount of consumption of the advertisement, or a combination thereof and the one or more criteria is rendered at the device concurrent with the advertisement for specifying the input to be provided by the user.

5. A method of claim 1, further comprising:
initiating, during delivery of the content, a rendering of an indicator at the device for indicating the content is approaching the predetermined threshold of bandwidth; and
determining an activation of the advertisement by the user based on the indicator,
wherein the indicator is a metering result, a content viewing duration or a prompt for requesting an input from the user for activation of the advertisement.

6. A method of claim 5, further comprising:
updating the indicator based on the amount of additional bandwidth allocated to the device,
wherein the indicator indicates a different quality or format of the content.

7. A method of claim 1, further comprising:
initiating a rendering of another advertisement at the device based on a determination that an amount of content delivered to the device is approaching a predetermined threshold of the additional bandwidth allocated to the device by the provider of the network.

8. A method of claim 1, further comprising:
retrieving the advertisement from a provider of the advertisement,
wherein the advertisement is retrieved based on the type of content delivered to the device, preferences of the user of the device or preferences of the provider of the advertisement.

9. A method of claim 1, wherein the advertisement is rendered to the display of the device concurrent with the content via a common user interface or via a separate user interface.

10. A method of claim 1, wherein the rendering of the advertisement is initiated based on an amount of time remaining for delivery of the content based on the metering of the content or based on a user input for specifying activation of the advertisement based on the metering of the content.

11. An apparatus comprising:
at least one processor; and
at least one memory including computer program code for one or more programs,
the at least one memory and the computer program code configured to, with the at least one processor, cause the apparatus to perform at least the following,
determine, based on a metering of content delivered to a user via a network, the amount of content delivered is approaching a predetermined threshold of bandwidth allocated to the user by a provider of the network;
initiate, at a device associated with the user, a rendering of an advertisement based on the determination;
monitor a duration or a type of interaction or response of the user to the advertisement; and
determine, based on the monitoring, an amount of additional bandwidth to be allocated to the device.

12. An apparatus of claim 11, wherein the apparatus is further caused to:
initiate allocation of the amount of additional bandwidth to the device,
wherein the additional bandwidth is associated with a different quality or format of the content or a disabling of the metering of the content.

13. An apparatus of claim 11, wherein the apparatus is further caused to:
determine, based on one or more criteria, the type of interaction or response of the user to the advertisement,
wherein the one or more criteria are defined by the provider of the advertisement or the provider of the network and the duration and type of interaction or response is based on an input provided by the user via the device.

14. An apparatus of claim 13, wherein the one or more criteria include a purchase action associated with the advertisement, a forwarding of the advertisement, an activation of the advertisement, a number or sequence of the inputs provided by a user, a storing of the advertisement, a ranking of the advertisement, an inquiry action associated with the advertisement, an amount of consumption of the advertisement, or a combination thereof and the one or more criteria is rendered at the device concurrent with the advertisement for specifying the input to be provided by the user.

15. An apparatus of claim 11, wherein the apparatus is further caused to:
initiate, during delivery of the content, a rendering of an indicator at the device for indicating the content is approaching the predetermined threshold of bandwidth; and
determine an activation of the advertisement by the user based on the indicator,
wherein the indicator is a metering result, a content viewing duration or a prompt for requesting an input from the user for activation of the advertisement.

16. An apparatus of claim 15, wherein the apparatus is further caused to:
update the indicator based on the amount of additional bandwidth allocated to the device,
wherein the indicator indicates a different quality or format of the content.

17. An apparatus of claim 11, wherein the apparatus is further caused to:
initiate a rendering of another advertisement at the device based on a determination that an amount of content delivered to the device is approaching a predetermined threshold of the additional bandwidth allocated to the device by the provider of the network.

18. An apparatus of claim 11, wherein the apparatus is further caused to:
retrieve the advertisement from a provider of the advertisement,
wherein the advertisement is retrieved based on the type of content delivered to the device, preferences of the user of the device or preferences of the provider of the advertisement.

19. An apparatus of claim 11, wherein the advertisement is rendered to the display of the device concurrent with the content via a common user interface or via a separate user interface.

20. An apparatus of claim 11, wherein the rendering of the advertisement is initiated based on an amount of time remaining for delivery of the content based on the metering of the content or based on a user input for specifying activation of the advertisement based on the metering of the content.
